(19) United States
(12) Patent Application Publication
(10) Pub. No.: US 2005/0162798 A1
(43) Pub. Date: Jul. 28, 2005

(54) Switch circuit and ignition apparatus employing the circuit

(75) Inventors: Naohito Kato, Kariya-city (JP); Motoo Yamaguchi, Anjo-city (JP); Yutaka Tomatsu, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO COPORATION, Aichi-pref. (JP)

(21) Appl. No.: 11/025,155

(22) Filed: Dec. 30, 2004

(30) Foreign Application Priority Data
Jan. 23, 2004 (JP) 2004-15914

(51) Int. Cl. H02H 3/18

(52) U.S. Cl. 361/111

(57) ABSTRACT

A semiconductor device includes a current detection cell including a current detection device and a main cell including a power device with a means for preventing the current detection cell from being damaged by an external surge. The main cell including a first IGBT as the power device and the current detection cell including a second IGBT as the current detection device are created as a semiconductor device on a P⁺ substrate. A surge protection resistor is connected to the emitter of the second IGBT of the current detection cell. If a surge current caused by the external surge makes an attempt to flow through the second IGBT of the current detection cell, the surge protection resistor will limit the magnitude of the current. Thus, the magnitude of the surge current will not become a very large value.

### CROSS REFERENCE TO RELATED APPLICATIONS

This application is based upon, claims the benefit of priority of, and incorporates by reference the contents of, Japanese Patent Application No. 2004-15914 filed on Jan. 23, 2004.

### FIELD OF THE INVENTION

The present invention relates to a switch circuit comprising a current detection cell and a main cell including a power device, and relates to an ignition apparatus employing the switch circuit.

### BACKGROUND OF THE INVENTION

Conventional semiconductor devices include a current detection device as the main cell, which includes a power device such as an IGBT or MOSFET, to detect the magnitude of current flowing to the main cell. One such semiconductor device is disclosed in Japanese Patent Laid-open No. Hei 60-94772, which is referred to as patent reference 1, the contents of which are incorporated herein by reference. In this semiconductor device, the cathodes of some of the transistor cells included in a power device are made independent and used as a current detection terminal of current detection cells.

In this structure, a current flowing to a switch circuit is split into a current flowing to the cathode of the main cell and a current flowing to a current detection terminal in the current detection cell. The current-split ratio is determined by a ratio of the area of a transistor cell connected to one of the electrodes (which are the aforementioned cathode and the current detection terminal cited above) to the area of another transistor cell connected to the other electrode. Thus, even without employing a shunt resistor having a large power tolerance, the small current flowing to the current detection terminal can be monitored for the purpose of sustaining a large magnitude of the current flowing to the main cell.

The semiconductor device described above is used for driving a load by turning the power device on and off to establish and de-establish electric conduction of the main cell. In the application of the semiconductor device to such an operation to drive a load, an external surge may be generated in some cases. FIG. 9 is a diagram showing current paths of surge currents caused by a generated external surge.

As shown in FIG. 9, when an external surge is generated, a surge current caused by the external surge flows through path A or B. Path A starts from a load 100 and continues between the collector and emitter of an IGBT 101 included in the current detection cell. On the other hand, path B starts from the ground terminal 102, continuing between the emitter and gate of an IGBT 103 included in the main cell and the following path between the gate and emitter of the IGBT 101 included in the current detection cell. It has been verified that, when such a surge current flows, the IGBT 101 included in the current detection cell is easily damaged by the surge current.

For example, consider path B. In this case, when a surge current is generated, the surge current flows through a capacitance existing between the emitter and gate of the IGBT 103 included in the main cell and a capacitance existing between the gate and emitter of the IGBT 101 included in the current detection cell. In this case, since the area of the emitter (which serves as a current detection terminal) of IGBT 101 included in the current detection cell is smaller than the area of the emitter (which serves as the cathode) of IGBT 103 included in the main cell, the IGBT 101 included in the current detection cell is damaged by a large surge current flowing through a small capacitance.

### SUMMARY OF THE INVENTION

In view of the problems discussed above, it is an object to prevent a current detection cell from being destroyed by an external surge in a semiconductor device comprising the current detection cell and a main cell including a power device.

In order to achieve the object, according to a first aspect, a semiconductor device comprises a main cell created on a semiconductor substrate having a first or second type of electrical conduction as a cell including a power device and a current detection cell also created on the semiconductor substrate as a cell including a current detection device having the same configuration as the power device; the power device in the memory cell has a gate, an emitter and a collector, whereas the current detection device in the current detection cell has the gate, an emitter and the collector. The collector is shared by the power device of the main cell and the current detection device of the current detection cell. The emitters are separated from each other. At least either a surge protection resistor or a surge protection inductor is connected to the emitter of the current detection device in the current detection cell.

In accordance with such a configuration, even if a surge current attempts to flow to the current detection device in the current detection cell, the current is limited by the surge protection resistor or the surge protection inductor so that the magnitude of the current hardly increases. Thus, even if a surge current caused by an external surge flows, the current detection device of the current detection cell can be prevented from being damaged by the current.

According to a second aspect, at least either the surge protection resistor or the surge protection inductor connected to the emitter is provided externally to the semiconductor substrate. That is, a configuration is possible in which the surge protection resistor or the surge protection inductor is provided externally to the semiconductor substrate.

According to a third aspect, the power device in the memory cell has a gate, an emitter and a collector, whereas the current detection device in the current detection cell has the gate, an emitter and the collector. The collector is shared by the power device of the main cell and the current detection device of the current detection cell. The emitters are separated from each other. At least either a surge protection resistor or a surge protection inductor is connected to the gate of the current detection device in the current detection cell.

As described above, according to the above aspect, the semiconductor has a configuration in which the surge protection resistor or the surge protection inductor is connected to the gate of the current detection device included in the current detection cell. Thus, even if an external surge is generated, causing a surge current to flow to the emitter of the current detection device included in the current detection cell by way of the gate of the current detection device included in the current detection cell, the current can be limited by the surge protection resistor or the surge protection inductor. As a result, the same effect as that of the first aspect can be achieved.

According to a fourth aspect, but also in this case, at least either the surge protection resistor or the surge protection inductor connected to the emitter of the current detection device included in the current detection cell can be provided externally to the semiconductor substrate.

According to a fifth aspect, the switch circuit described according to any of the first to fourth aspects can further have a driving circuit for controlling a voltage applied to the gate shared by the power device of the main cell included in the switch circuit and the current detection device of the current detection cell also included in the switch circuit; and a current detection circuit for detecting a current flowing between the emitter and collector of the current detection device in the current detection cell. The switch circuit can be applied to an ignition apparatus having a configuration in which electrical conductivity of an ignition coil is controlled by the power device of the main cell included in the switch circuit to control a discharge phenomenon of an ignition plug.

### BRIEF DESCRIPTION OF THE DRAWINGS

FIG. 1 is a diagram showing a cross section of a semiconductor device implemented according to a first embodiment;

FIG. 2 is a diagram showing an equivalent circuit of the semiconductor device shown in FIG. 1;

FIG. 3 is a diagram showing surge current paths generated in the semiconductor device S of FIG. 2 in the event of an external surge;

FIG. 4 is a diagram showing the circuit configuration of a semiconductor device S implemented according to a second embodiment;

FIG. 5 is a diagram showing the circuit configuration of a third embodiment implementing a combination of the semiconductor device S implemented by the first embodiment and a control device;

FIG. 6 is a diagram showing the circuit configuration of a fourth embodiment implementing an application of the semiconductor device S implemented by the first or second embodiment to an ignition apparatus used in a vehicle;

FIG. 7 is a diagram showing a cross section of a semiconductor device S implemented by another embodiment;

FIG. 8 is a diagram showing a cross section of a semiconductor device S implemented by a further embodiment; and

FIG. 9 is a diagram showing surge current paths caused by an external surge generated in a related art semiconductor device S.

### DETAILED DESCRIPTION OF THE PREFERRED EMBODIMENTS

### First Embodiment

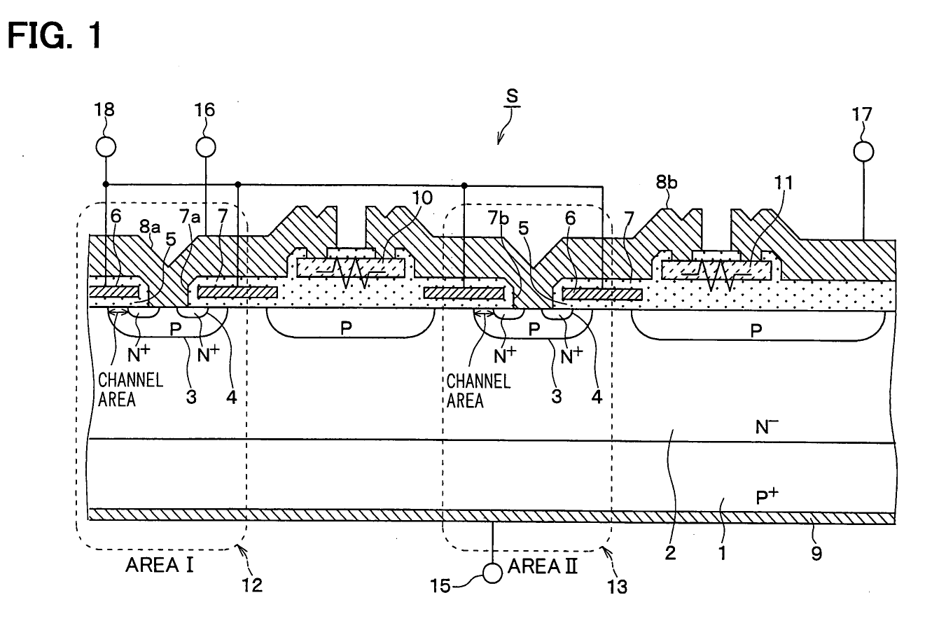

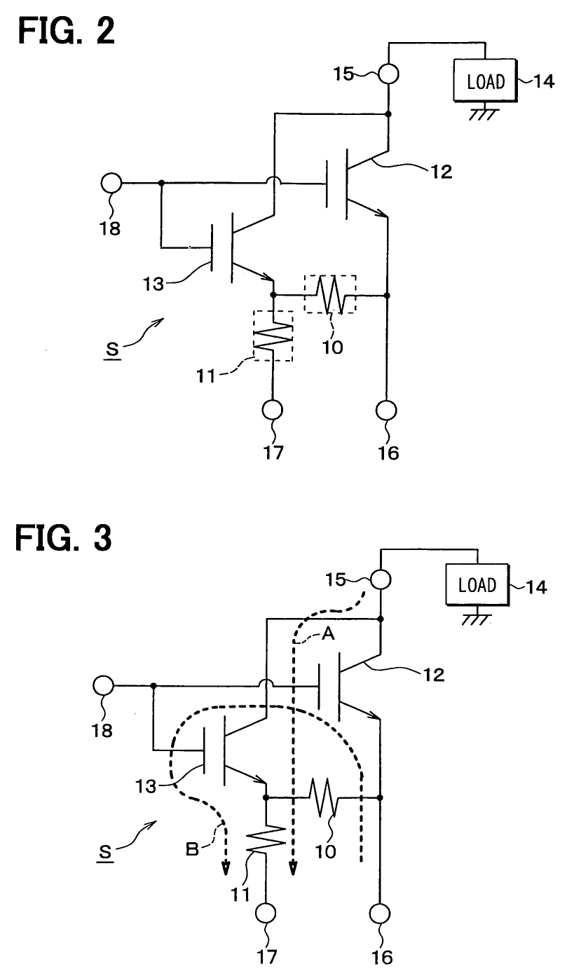

A first embodiment of the present invention is explained by referring to FIG. 1. FIG. 1 is a diagram showing a cross-sectional configuration of a semiconductor device S implemented by the embodiment of the present invention. FIG. 2 is a diagram showing an equivalent circuit of the semiconductor device S shown in FIG. 1. The embodiment implements a typical configuration of a switch circuit created as a circuit based on the semiconductor device S. The configuration of the semiconductor device S implemented by the embodiment is explained by referring to FIGS. 1 and 2 as follows.

An area I shown in FIG. 1 is an end portion of a main cell in which an insulated gate bipolar transistor (IGBT) 12 is created to serve as a power device. An area 11 is an end portion of a current detection cell in which an IGBT 13 having the same configuration as the IGBT 12 is created to serve as a current detection device.

As shown in FIG. 1, the IGBT 12 in the main cell comprises an N-drift layer 2 created on a P⁺ substrate 1, a P body layer 3 created on the surface of the N-drift layer 2 and an N⁺ emitter layer 4 created on the surface of the P body layer 3. In addition, a surface layer of the P body layer 3 provided between the N-drift layer 2 and the N⁺ emitter layer 4 is used as a channel area. On the surface of the P body layer 3, a gate 6 is created, sandwiching a gate oxidation film 5 in conjunction with the surface. Furthermore, an interlayer insulation film 7 is created to cover the gate 6, and an emitter 8a is created to cover the interlayer insulation film 7. The emitter 8a has a configuration of being electrically connected to the P body layer 3 and the N⁺ emitter layer 4 through a contact hole 7a created on the interlayer insulation film 7. Then, a collector 9 is created on the back face of the P⁺ semiconductor substrate 1.

On the other hand, the current detection device in the current detection cell is implemented as an IGBT 13, which has the same configuration as the IGBT 12 in the main cell. The IGBT 13 composing the current detection device is created by carrying out the same process as the IGBT 12. The IGBT 13 has an emitter 8b electrically separated from the emitter 8a of the IGBT 12. The emitter 8b has a configuration of being electrically connected to the P body layer 3 and the N⁺ emitter layer 4 through a contact hole 7b created on the interlayer insulation film 7.

Subsequently, on the back face of the semiconductor substrate 1, the collector 9 serving as an electrode common to the main cell and the current detection cell is created.

In addition, a current detection resistor 10 made of multi-crystal silicon is created on the interlayer insulation film 7 between the main cell and the current detection cell. The current detection resistor 10 is electrically connected to the emitter 8a of the main cell and the emitter 8b of the current detection cell.

Furthermore, a surge protection resistor 11 made of multi-crystal silicon is provided on the interlayer insulation film 7 at a position adjacent to the main cell, and an electrode (or a terminal) 17 is electrically connected to this surge protection resistor 11. The resistance of the surge protection resistor 11 is set to a value within the range of 100 ohms to 5 kiloohms or, ideally, to a value within the range of approximately 200 ohms to 1 kiloohm. Typically, the resistance of the surge protection resistor 11 has a value of 500 ohms. The terminal 17 is typically connected to a circuit external to the semiconductor device S such as, for example, a current detection circuit. In such a connection, the terminal 17 passes on a current flowing through the surge protection resistor 11 to the external current detection circuit.

An equivalent circuit shown in FIG. 2 represents the semiconductor device S having such a configuration. As shown in the figure, the IGBT 12 composing the main cell and the IGBT 13 composing the current detection cell share the same collector 9 in common. The collector 9 is connected to a terminal 15, which is connected to a load 14. The emitter 8a of the IGBT 12 is connected to a ground terminal 16 whereas the emitter 8b of the IGBT 13 is connected to the terminal 17 through the surge protection resistor 11. The emitter 8a of the IGBT 12 is connected to the emitter 8b of the IGBT 13 by a current detection resistor 10. The gate 6 of the IGBT 12 and the gate 6 of the IGBT 13 are connected to a gate control terminal 18. In this configuration, the IGBT 12 and the IGBT 13 can be driven to on and off states based on a voltage applied to the gate control terminal 18.

Next, the operation of the semiconductor device S having such a configuration is explained as follows.

In the semiconductor device S described above, when the IGBT 12 of the main cell is turned on by a gate control voltage applied to the gate control terminal 18, the IGBT 13 of the current detection cell is also turned on. Since the configuration of the IGBT 12 of the main cell is the same as the configuration of the IGBT 13 of the current detection cell, a current having a magnitude proportional to the magnitude of a current flowing through the IGBT 12 of the main cell flows through the IGBT 13 of the current detection cell. Thus, by detecting the current flowing through the IGBT 13 of the current detection cell, the magnitude of the current flowing through the IGBT 12 of the main cell can be measured.

More specifically, the electric potential appearing at the emitter 8b of the IGBT 13 is determined by a voltage drop along the current detection resistor 10. Thus, the difference between this electric potential and an electric potential appearing at the terminal 17 as well as the resistance of the surge protection resistor 11 determine the magnitude of a current flowing through the surge protection resistor 11. It is to be noted that, since the resistance of the surge protection resistor 11 is set at a large value as described above, the magnitude of the detected current is small. However, the current detection circuit for detecting the current merely needs to be designed as a circuit capable of keeping up with high impedance.

The following description explains an event in which an external surge is generated in the semiconductor device S implemented by the embodiment. FIG. 3 is a diagram showing surge current paths generated in the event of an external surge.

As shown by the dashed-line arrows in the figure, a surge current flows through path A or B. Path A starts from the load 14 and continues through a terminal 15 between the collector and emitter of the IGBT 13 included in the current detection cell. On the other hand, path B starts from the ground terminal 16, continuing between the emitter and gate of the IGBT 12 included in the main cell and the following path between the gate and emitter of the IGBT 13 included in the current detection cell.

In the case of either path, the surge current flows through the surge protection resistor 11. Thus, the magnitude of the surge current is limited by the surge protection resistor 11. In addition, in this embodiment, since the resistance of the surge protection resistor 11 is set at a large value such as 500 ohms as described above, the magnitude of the surge current is restrained to a small value. Accordingly, assuming that the surge current flows through path B, for example, since the magnitude of the surge current is not so large, the IGBT 13 will not be damaged by the surge current even if the semiconductor device S is designed into a configuration in which the emitter 8b of the IGBT 13 included in the current detection cell is small in comparison with the emitter 8a of the IGBT 12 included in the main cell.

By providing the embodiment with a configuration described above, the IGBT 13 of the current detection cell can be prevented from being damaged by a surge current caused by an external surge.

### Second Embodiment

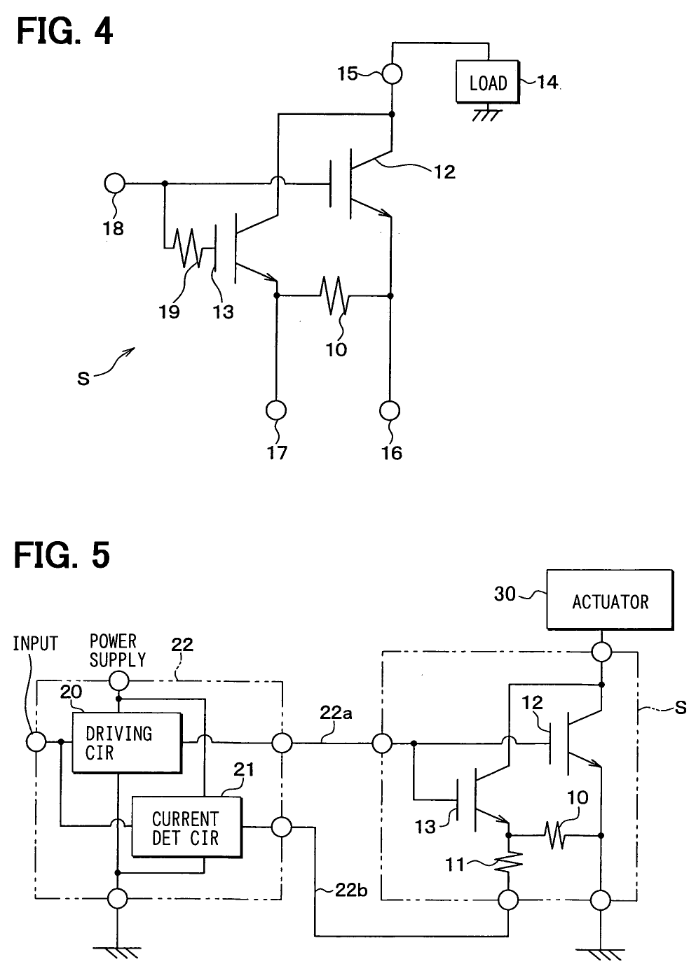

Next, a second embodiment will explained with reference to FIG. 4, which is a diagram showing the circuit configuration of a semiconductor device S implemented by the second embodiment. This embodiment also implements a switch circuit based on the semiconductor device S. The semiconductor device S implemented by the embodiment is explained by referring to FIG. 4 as follows. Since main elements composing the semiconductor device S are identical with their counterparts employed in the first embodiment shown in FIG. 1, only differences between the first and second embodiments are described. The main elements identical with their counterparts are denoted by the same reference numerals as the counterparts, and their descriptions are not repeated to avoid duplications.

In the case of the second embodiment, in place of the gate control terminal 18 employed in the first embodiment as shown in FIG. 2, a surge protection resistor 19 is provided between the gate 6 of the IGBT 13 included in the current detection cell and the gate control terminal 18 as shown in FIG. 4. The resistance of the surge protection resistor 19 is set at a value within the range of 100 ohms to 5 kiloohms or, desirably, the range of 200 ohms to 1 kiloohm. Typically, the resistance of the surge protection resistor 19 is set at 500 ohms. Other configurations are identical with the first embodiment.

When a surge current coming from the ground terminal 16 flows through a path between the emitter and gate of an IGBT 12 included in the main cell and the following path between the gate and emitter of the IGBT 13 included in the current detection cell in the semiconductor device S having such a configuration, that is, paths corresponding to path B shown in FIG. 3 as a path of a surge current in the first embodiment, the surge current must obviously flow through the surge protection resistor 19 included in one of the paths.

Thus, since the resistance of the surge protection resistor 19 is set at a large value such 500 ohms as described above, the magnitude of the surge current flowing through the paths is restrained to a small value. Accordingly, assuming that the surge current flows through these paths, for example, since the magnitude of the surge current is not so large, the IGBT 13 will not be damaged by the surge current even if the area of the emitter 8b of the IGBT 13 included in the current detection cell is small in comparison with the area of the emitter 8a of the IGBT 12 included in the main cell.

By providing the embodiment with a configuration described above, the IGBT 13 of the current detection cell can be prevented from being damaged by a surge current caused by an external surge.

### Third Embodiment

Next, a third embodiment will be explained. The third embodiment implements a circuit configuration comprising a combination of the semiconductor device S implemented by the first embodiment and a control device as the configuration of a circuit for driving an actuator. FIG. 5 is a diagram showing the circuit configuration in which the semiconductor device S implemented by the first embodiment is applied to a switch circuit for driving an actuator. The circuit configuration of the third embodiment is explained by referring to FIG. 5 below. Since the semiconductor device S itself is identical to the first embodiment shown in FIG. 2, in the semiconductor device S, elements identical with their counterparts are denoted by the same reference numerals as the counterparts, and their descriptions are not repeated to avoid duplications.

As shown in FIG. 5, the switch circuit implemented by the third embodiment comprises the semiconductor device S implemented by the first embodiment and a control IC 22 including a driving circuit 20 and current detection circuit 21. The driving circuit 20 is a circuit for receiving a control signal from typically an ECU not shown in the figure. The control IC 22 and the semiconductor device S are electrically connected to each other by bonding wires 22a and 22b.

The control IC 22 has a power-supply terminal connected to a power supply and a terminal connected to the bonding wire 22a for wiring the driving circuit 20 included in the control IC 22 to the gate control terminal 18 of the semiconductor device S. The gate control terminal 18 is internally connected to the gate of the IGBT 12 included in the main cell and the gate of the IGBT 13 of the current detection cell. The control IC 22 also has another terminal connected to the terminal 17 by the bonding wire 22b. This other terminal is connected internally in the control IC 22 to the current detection circuit 21. As described earlier, the terminal 17 is connected internally in the semiconductor device S to the emitter 8b of the IGBT 13 included in the current detection cell by the surge protection resistor 11. On the semiconductor device S, the terminal 15 is connected internally to the collector 9 of the IGBT 12 and the IGBT 13, which are included in the main cell. The terminal 15 is connected externally to an actuator 30, which is driven by the control IC 22.

Based on a voltage applied by the power supply, the driving circuit 20 outputs a control signal having high and low levels for turning on and off the IGBTs 12 and 13.

Typically, the current detection circuit 21 comprises an operational amplifier and a resistor connected in series to the IGBT 13. An electric potential appearing at one end of the resistor is supplied to an inverting input terminal of the operational amplifier and an electric potential appearing at the other end of the resistor is supplied to a non-inverting input terminal of the operational amplifier. A signal output by the operational amplifier is supplied to the driving circuit 20.

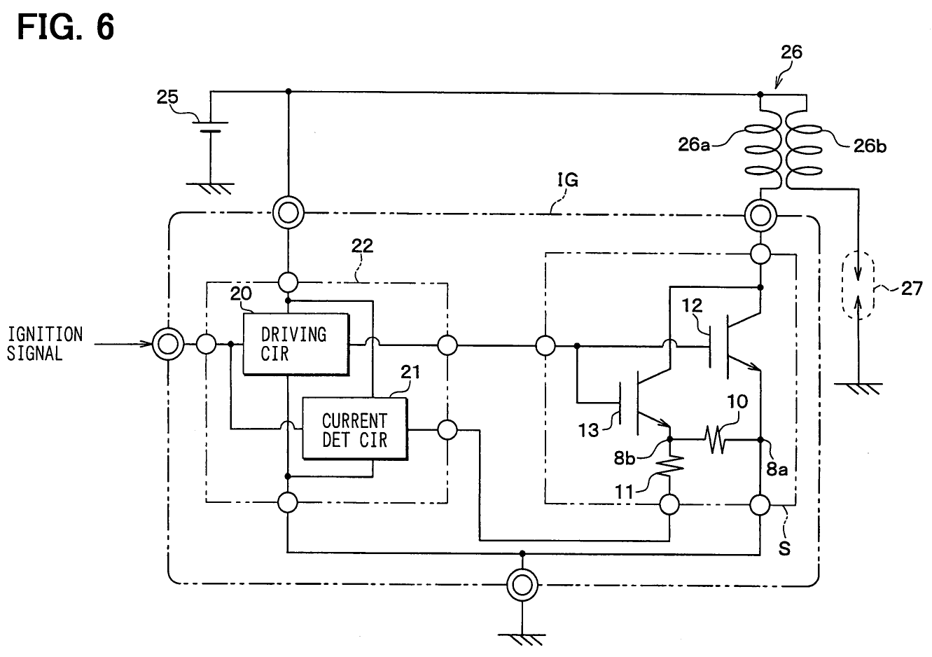

In a configuration as discussed above, when the control signal generated by the driving circuit 20 turns the IGBTs 12 and 13 on and off, a current flowing through the primary winding 26a of an ignition coil 26 (shown in FIG. 6) is also turned on an off. When this current is cut off, a high voltage appears across the secondary winding 26b of the ignition coil 26, causing a discharge phenomenon in an ignition plug 27.

A current flowing through the primary winding 26a is split into a current flowing through the emitter and collector of the IGBT 12 and a current flowing through the emitter and collector of the IGBT 13. The current flowing through the emitter and collector of the IGBT 13 is proportional to the current flowing through the emitter and collector of the IGBT 12, and also flows to the current detection circuit 21, which then detects the magnitude thereof. More fully, the difference in electric potential between the ends of the resistor employed in the current detection circuit 21 varies in accordance with changes of the current flowing through the IGBT 13 of the current detection cell. Such changes in current are amplified by the operational amplifier employed in the current detection circuit 21 before being supplied to the driving circuit 20 as a feedback quantity. In this way, the driving circuit 20 executes feedback control of the IGBT 12 included in the main cell.

As described above, the semiconductor device S implemented by the first embodiment can be incorporated in the circuit configuration of the third embodiment. In addition, when an external surge is generated in such a circuit configuration, a surge current flows through path A or B as shown in FIG. 3. Since the semiconductor device S implemented by the first embodiment includes the surge protection resistor 11, however, the magnitude of the surge current is small. Thus, the IGBT 13 of the current detection cell provided in the semiconductor device S can be prevented from being damaged by the surge current and, therefore, a large surge current can be prevented from flowing to the current detection circuit 21.

### Fourth Embodiment

Next, a fourth embodiment will be explained. The fourth embodiment concretely implements a circuit configuration comprising a combination of the semiconductor device S implemented by the first embodiment and a control device. The fourth embodiment is taken as an example for exemplifying a case in which the semiconductor device S implemented by the first embodiment is applied to an ignition apparatus IG used in a vehicle. FIG. 6 is a diagram showing the circuit configuration of the ignition apparatus IG implemented by the fourth embodiment. The circuit configuration of the fourth embodiment is explained below by referring to FIG. 6. Since the basic configuration of this ignition apparatus IG is similar to the third embodiment, however, in the ignition apparatus IG, elements identical with their counterparts employed in the third embodiment shown in FIG. 5 are denoted by the same reference numerals as the counterparts and their descriptions are not repeated to avoid duplications.

As shown in FIG. 6, the ignition apparatus IG has a configuration comprising the semiconductor device S implemented by the first embodiment and a control IC 22 including a driving circuit 20 and current detection circuit 21. The driving circuit 20 is a circuit for receiving a control signal from typically an engine ECU not shown in the figure. The ignition apparatus IG is connected to a battery 25 serving as a power supply and the terminal 15 of the semiconductor device S is connected to the primary winding 26a of an ignition coil 26.

In such a configuration, when the control signal generated by the driving circuit 20 turns the IGBTs 12 and 13 on, a current flows through the primary winding 26a of an ignition coil 26. While this current is flowing, a high voltage appears across the secondary winding 26b of the ignition coil 26, causing a discharge phenomenon in an ignition plug 27.

A current flowing through the primary winding 26a is split into a current flowing through the emitter and collector of the IGBT 12 and a current flowing through the emitter and collector of the IGBT 13. The current flowing through the emitter and collector of the IGBT 13 is proportional to the current flowing through the emitter and collector of the IGBT 12, and also flows through the surge protection resistor 11 to the current detection circuit 21, which then detects the magnitude thereof. That is, the difference in electric potential between the ends of the resistor employed in the current detection circuit 21 varies in accordance with changes of the current flowing through the IGBT 13 of the current detection cell. Such changes in current are amplified by the operational amplifier employed in the current detection circuit 21 before being supplied to the driving circuit 20 as a feedback quantity. In this way, the driving circuit 20 executes feedback control of the IGBT 12 included in the main cell.

As described above, in an application of the semiconductor device S implemented by the first embodiment to the ignition apparatus IG provided by the fourth embodiment, the ignition apparatus IG controls the ignition plug 27 through the ignition coil 26. Thus, external surges are generated more frequently. Also in such a case, a surge current caused by an external surge flows through path A or B in the first embodiment. Since the semiconductor device S implemented by the first embodiment includes the surge protection resistor 11, however, the magnitude of the surge current is small. Thus, the IGBT 13 of the current detection cell provided in the semiconductor device S can be prevented from being damaged by the surge current and, in addition, a large surge current can be prevented from flowing to the current detection circuit 21.

### Other Embodiments

In the embodiments described above, the switch circuit includes only the semiconductor device S in which the surge protection resistor 11 or 19 limits the magnitude of a surge current. However, the surge protection resistor 11 or 19 can also be provided as a resistor external to the semiconductor device S.

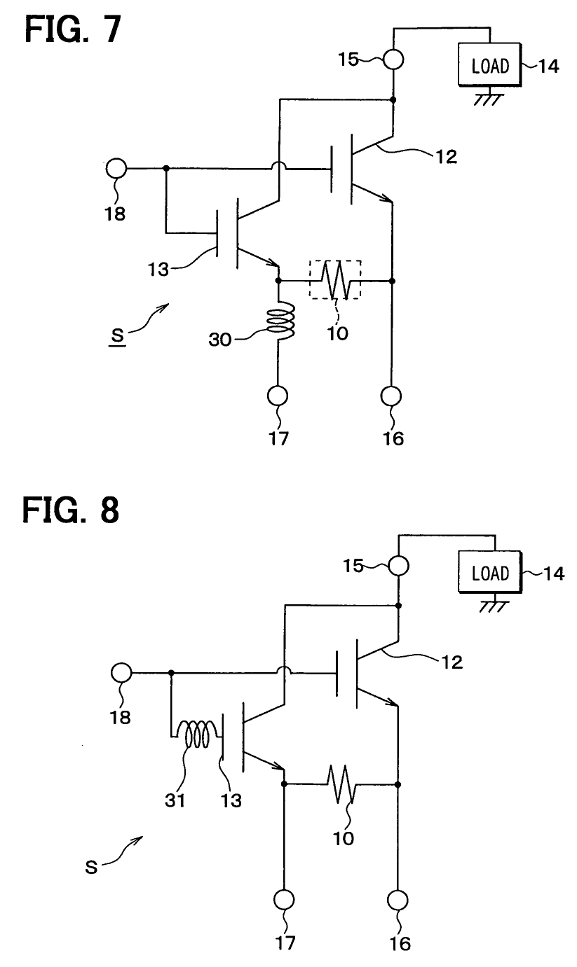

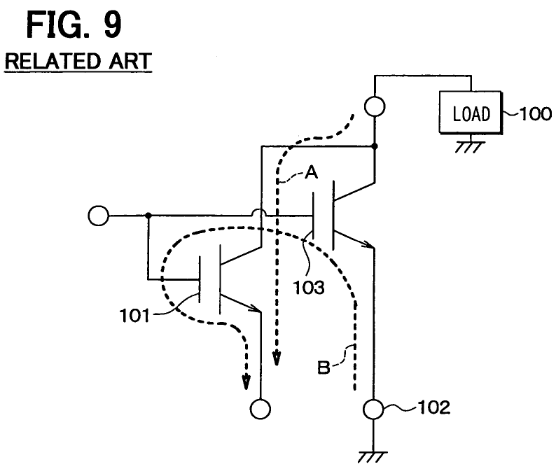

In addition, in place of the surge protection resistor 11 or 19 or in conjunction with the surge protection resistor 11 or 19, a surge protection inductor can also be used. FIG. 7 is a diagram showing a typical circuit configuration obtained by replacing the surge protection resistor 11 employed in the circuit configuration of the first embodiment with a surge protection inductor 30. By the same token, FIG. 8 is a diagram showing a typical circuit configuration obtained by replacing the surge protection resistor 19 employed in the circuit configuration of the second embodiment with a surge protection inductor 31. In this way, in the case of the first embodiment, in place of the surge protection resistor 11 or in conjunction with the surge protection resistor 11, a surge protection inductor 30 can also be used. By the same token, in the case of the second embodiment, in place of the surge protection resistor 19 or in conjunction with the surge protection resistor 19, a surge protection inductor 31 can also be used. Generally, a surge protection device, such as, for example, surge protection resistor 19 or surge protection inductor 31, is utilized.

In addition, the surge protection inductor 30 can be provided as an inductor external to the semiconductor device S. As shown in FIG. 7, for example, the surge protection inductor 30 is applied to the configuration of the first embodiment. However, the surge protection inductor 30 can also be connected as an external inductor to the terminal 17, which is connected directly to the emitter 8b of the IGBT 13 in the current detection cell of the semiconductor device S. On the other hand, FIG. 8 shows an application of the surge protection inductor 31 to the configuration of the second embodiment. In this case, a gate control terminal 18 is connected directly to the gate 6 of the IGBT 12 in the main cell of the semiconductor device S whereas another gate control terminal 18 is connected directly to the gate 6 of the IGBT 13 in the current detection cell of the semiconductor device S, and the surge protection inductor 31 can be connected as an external inductor to the other gate control terminal 18.

With a surge protection inductor provided as described above, even for an AC surge current generated by an electrostatic surge, for example, variations in electric potential can be suppressed. Thus, the switch circuit is also capable of effectively coping with an AC surge current.

As described above, the fourth embodiment implements an application of the semiconductor device S provided by the first embodiment to a circuit for driving an actuator whereas the fourth embodiment implements an application of the semiconductor device S to an ignition apparatus IG. However, the semiconductor device S provided by the second embodiment can also be applied to the circuit for driving the actuator and the ignition apparatus IG.

The embodiments employ IGBTs as typical devices. However, the embodiments can also be applied to another semiconductor device S employing a power MOSFET adopting the N type of electrical conduction as a replacement of the conduction type of the P⁺ substrate 1 used as a semiconductor substrate shown in FIG. 1. In addition, in the embodiments, the N type of electrical conduction and the P type of electrical conduction are respectively used as the first and second conduction type of the semiconductor device S. However, the P type of electrical conduction and the N type of electrical conduction can also be conversely used respectively as the first and second conduction types of the semiconductor device S.

In addition, in the semiconductor device S of each of the embodiments described above, the IGBTs 12 and 13 having entirely the same cross-sectional configurations are used as respectively the power device of the main cell and the current detection device of the current detection cell. In the present invention, however, by the same cross-sectional configurations, the same device structures are meant. Thus, even if the power device composing the main cell and the current detection device composing the current detection cell have different channel lengths and different channel widths, the device structure of the main cell is the same as the device structure of the current detection cell. Thus, the cross-sectional structure of the main cell does not need to be exactly the same as the cross-sectional structure of the current detection cell.

1. A switch circuit implemented as a semiconductor device comprising a main cell created on a semiconductor substrate having a first or second type of electrical conduction as a cell including a power device, and a current detection cell also created on the semiconductor substrate as a cell including a current detection device having the same configuration as the power device, wherein:
the power device in the main cell has a gate, an emitter and a collector, whereas the current detection device in the current detection cell has the gate, an emitter and the collector;
the collector is shared by the power device of the main cell and the current detection device of the current detection cell;
the emitters are separated from each other; and
at least either a surge protection resistor or a surge protection inductor is connected to the emitter of the current detection device in the current detection cell.

2. A switch circuit according to claim 1, wherein at least either the surge protection resistor or the surge protection inductor connected to the emitter is provided externally to the semiconductor substrate.

3. A switch circuit implemented as a semiconductor device comprising a main cell created on a semiconductor substrate having a first or second type of electrical conduction as a cell including a power device, and a current detection cell also created on the semiconductor substrate as a cell including a current detection device having the same configuration as the power device, wherein:
the power device in the main cell has a gate, an emitter and a collector whereas the current detection device in the current detection cell has the gate, an emitter and the collector;
the collector is shared by the power device of the main cell and the current detection device of the current detection cell;
the emitters are separated from each other; and
at least either a surge protection resistor or a surge protection inductor is connected to the gate of the current detection device in the current detection cell.

4. A switch circuit according to claim 3, wherein at least either the surge protection resistor or the surge protection inductor connected to the gate is provided externally to the semiconductor substrate.

5. An ignition apparatus comprising:
a switch circuit according to claim 3;
a driving circuit for controlling a voltage applied to the gate shared by the power device in the main cell of the switch circuit and the current detection device in the current detection cell of the switch circuit; and
a current detection circuit for detecting a current flowing between the emitter and collector of the current detection device in the current detection cell,
wherein the power device in the main cell of the switch circuit controls electrical conduction of an ignition coil so as to control a discharge phenomenon of an ignition plug.

6. An ignition apparatus comprising:
a switch circuit according to claim 1;
a driving circuit for controlling a voltage applied to the gate shared by the power device in the main cell of the switch circuit and the current detection device in the current detection cell of the switch circuit; and
a current detection circuit for detecting a current flowing between the emitter and collector of the current detection device in the current detection cell,
wherein the power device in the main cell of the switch circuit controls electrical conduction of an ignition coil so as to control a discharge phenomenon of an ignition plug.

7. A semiconductor device comprising:
a main cell comprising a first bipolar transistor for providing a power device;
a current detection cell comprising a second bipolar transistor for providing a current detection device, wherein the first bipolar transistor and the second bipolar transistor have a common collector, wherein a magnitude of current in the second bipolar transistor is substantially proportional to a magnitude of current in the first bipolar transistor;
a current detection resistor connected to the emitter of the first bipolar transistor and the emitter of the second bipolar transistor for detecting current at the emitter of the second bipolar transistor; and
a surge protection device connected to the second bipolar transistor for limiting a surge current to prevent the surge current from damaging the second bipolar transistor.

8. The semiconductor device of claim 7, wherein the surge protection device comprises a surge protection resistor having a value within the range 100 ohms to 5 kiloohms.

9. The semiconductor device of claim 7, wherein the surge protection device is connected to the emitter of the second bipolar transistor.

10. The semiconductor device of claim 7, wherein the surge protection device is connected to a gate of the second bipolar transistor.

11. The semiconductor device of claim 7, wherein the surge protection device is connected to either the gate or the emitter of the second bipolar transistor, wherein the common collector is connected to an ignition coil, wherein the gate of the first and second bipolar transistor is connected to a driving circuit, wherein the emitter of the second bipolar transistor is connected to a current detector circuit.
